(19) United States
(12) Patent Application Publication
(10) Pub. No.: US 2002/0070717 A1
(43) Pub. Date: Jun. 13, 2002

(54) Apparatus and methods for boosting power supplied at a remote node

(76) Inventor: John Pellegrino, Westford, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/731,451

(22) Filed: Dec. 7, 2000

(51) Int. Cl. G05F 1/613

(52) U.S. Cl. 323/223

(57) ABSTRACT

Apparatus and methods for boosting power supplied at a remote node in a distributed power system in response to a feedback signal derived from a measured voltage at a remote node include, in one embodiment, a power system with remote boost regulation employing a variable power supply and a remote active boost regulator working in coordination. The remote active boost regulator monitors the variable power supply output voltage; using an amplifier, compares the measured voltage with a reference voltage; and generates a feedback signal. The feedback signal is delivered to a variable power supply causing the power supply to increase, or boost, output voltage to compensate for distribution losses and remote loading.

### FIELD OF THE INVENTION

The present invention relates generally to electrical power systems and specifically to varying nominal power supply output in response to a remote sense input.

### BACKGROUND OF THE INVENTION

In low voltage distributed power systems known to the prior art and shown in FIG. 1, a bulk power supply 10 provides one or more voltages to a number of distributed electronic loads 12A through 12N (generally 12). These loads 12 may be individual chassis within an equipment rack, or removable circuit cards connected to a computer motherboard or back-plane.

The voltage levels at the individual loads 12 will be less than the rated output of the bulk power supply. This reduced power level at the loads results from power loss, or voltage “drop,” across current-carrying conductors of the power distribution system. This voltage drop results from the power supply current interacting with an equivalent impedance of the current-carrying conductors. FIG. 1 is a schematic representation of a distributed power system where the equivalent impedance of each segment of the power distribution system is shown in phantom view as resistors 14 and 16A through 16N (generally 16). Resistors (14 or 16) are shown in phantom because they represent the equivalent impedance due to the finite conductivity of the physical conductors and are not actual resistors. The magnitude of the voltage drop within any segment of the power distribution system is determined as the value of current flowing through that segment multiplied by the equivalent impedance value flowing within that segment.

Thus, without compensation, a voltage “droop” occurring at the loads may impact performance by introducing errors, such as logical errors where logic levels of a particular circuit card are operating outside of their applicable specified input power values, or perhaps even in hardware faults for similar reasons.

Although many techniques have been tried to solve this problem, the most sophisticated to date has been to use standard, commercially available variable bulk power supplies with remote sensing, where the voltage at a remote point can be increased above the supply's nominal rated output power by reporting a remote sense signal that is less than the actual sensed value. The variable bulk power supply increases its output to overcome the power distribution system loss and the artificial offset value. Current systems perform the artificial offset to the remote sense signal with resistive networks. The resistive networks are carefully designed to provide a fixed impedance value. The impedance value is selected to cause a controlled offset to the remote sense signal and induce the desired overall increase, “boost,” in supplied power.

Although conceptually straightforward, implementation of a resistive network approach presents practical limitations. When selecting resistor values to fabricate the resistive network, the internal impedance of the bulk variable power supply must be included. Incorporation of the power supply impedance into the equation necessarily ties the design of the resistive network to the selected power supply. A power supply internal impedance typically varies between devices, for reasons related to the power supply's internal architecture and selected fabrication components. Substituting one power supply for another into a circuit including a resistive network designed to increase the remote voltage by a predetermined amount can result in a variation of the voltage supplied to the distributed loads that again could result in voltage droops, or conversely, could create excessive voltage resulting in damage to the loads. The present invention avoids this problem.

### SUMMARY OF THE INVENTION

The present invention relates to apparatus and methods for boosting power supplied at a remote node in a distributed power system. One embodiment of the invention boosts a regulated voltage at a remote point in a distributed power system to compensate for additional distribution losses beyond the point of regulation. The techniques disclosed are independent of the internal impedance characteristic of the variable power supply source.

In one aspect, a power system with remote boost regulation employs a variable power supply and a remote active boost regulator working in coordination, where the remote active boost regulator monitors the variable power supply output voltage and generates a feedback signal. In this embodiment, the feedback signal is delivered to the variable power supply causing the power supply to increase, or boost, its output compensating for distribution losses and remote loading.

One feature of the invention in one embodiment is the remote active boost regulator including a differential voltage amplifier which itself uses a reference voltage source. The reference voltage source is compared with the measured signal from the remote sensed voltage and the differential amplifier output is adjusted accordingly.

In another aspect, a power system with remote boost regulation for connection with a variable power supply where the remote active boost regulator monitors the variable power supply output voltage and generates a feedback signal. In this embodiment, the feedback signal is delivered to the variable power supply causing the power supply to increase, or boost, its output compensating for distribution losses and remote loading.

In yet another aspect, a method for reducing the effect of transmission losses in a distributed power system where a voltage is measured at a remote point in the distributed power system, the measured value is compared with a reference voltage value, and a changing feedback signal is generated in response to any differences between the measured and reference values. In this embodiment, the feedback signal is provided to a variable power source causing an increase, or a boost voltage, by an amount that is proportional to the feedback signal.

### BRIEF DESCRIPTION OF THE DRAWINGS

The invention is pointed out with particularity in the appended claims. The drawings are not necessarily to scale, emphasis instead generally being placed upon illustrating the principles of the invention. Like reference characters in the respective drawing figures indicate corresponding parts. The advantages of the invention described above, as well as further advantages of the invention, may be better understood by reference to the description taken in conjunction with the accompanying drawings, in which:

FIG. 1 is a block diagram of a distributed load power system known to the prior art;

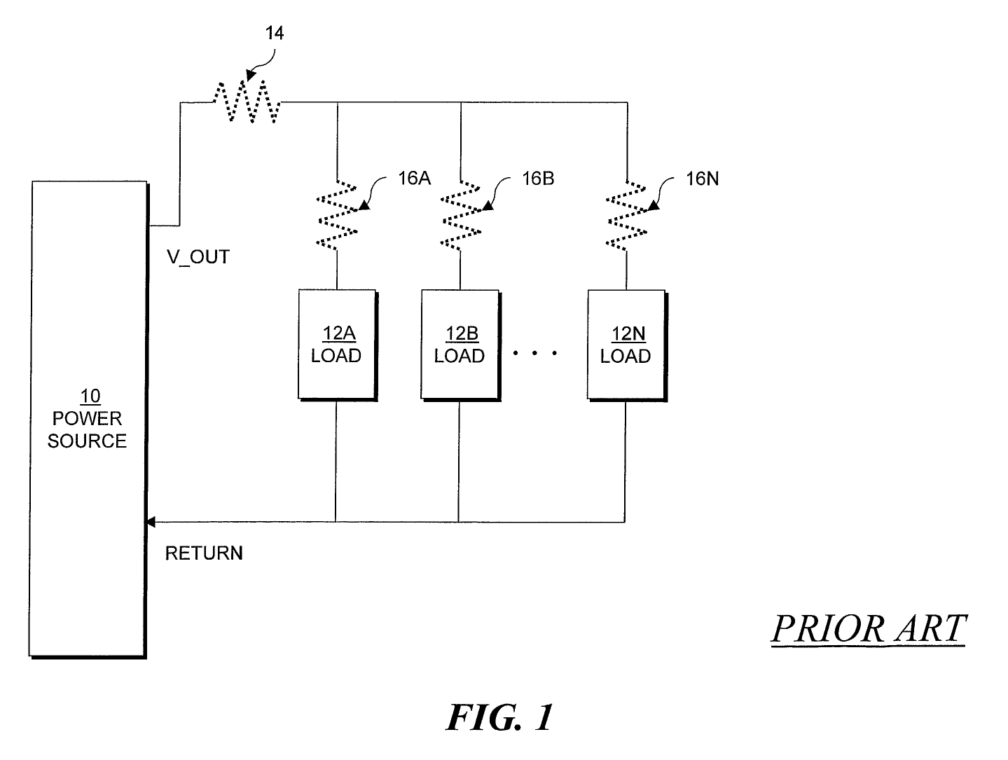

FIG. 2 is a block diagram of an embodiment of an electrical power system;

FIG. 3 is a block diagram of an embodiment of a variable power source;

FIG. 4 is a block diagram of an embodiment of a remote active regulator; and

FIG. 5 is a flowchart of an embodiment of a variable power source with remote active regulation.

### DETAILED DESCRIPTION OF THE INVENTION

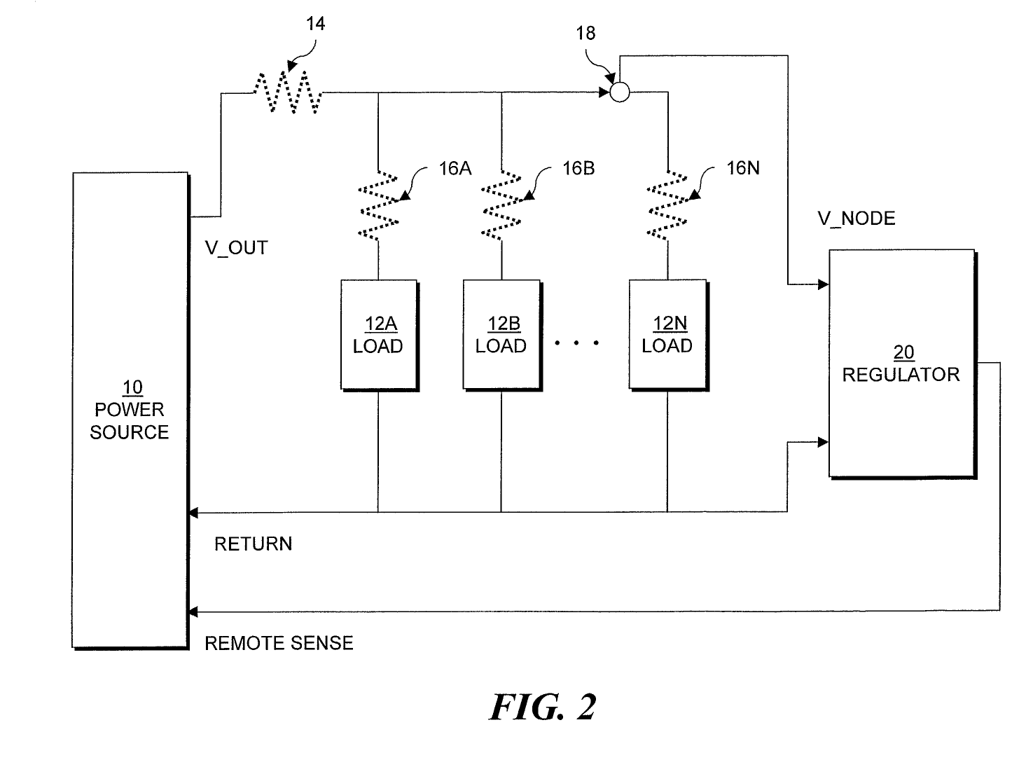

Referring now to FIG. 2, an embodiment of a power distribution system is shown in which the present invention can be used. The system includes a variable power supply 10, a plurality of electrical loads 12A through 12N (generally 12) and a remote active boost regulator 20. The variable power supply 10 has at least three terminals: a supply output terminal (V_OUT) providing a supply voltage; a supply input terminal sensing a feedback signal (REMOTE SENSE); and a supply sense return terminal (RETURN). The remote active boost regulator 20 also has at least three terminals: a regulator input terminal; a regulator sense return terminal; and a regulator output terminal.

In one embodiment, the loads 12 represent electronic circuit cards; whereas, other embodiments, the loads may represent separate system components, modules, or any other element requiring electrical power. The configuration of the loads 12 can be lumped, where the loads are located in close proximity to each other, or distributed, where the loads are separated by conductors of the power distribution system. For either configuration of the loads 12, some or all of the loads 12 may be located remotely from the variable power supply 10. FIG. 2 is an electrical schematic representation of the power distribution system; therefore, the physical separation distances between the loads 12 and the variable power supply 10 are not depicted.

The variable power supply 10 supply output terminal (V_OUT) is in electrical communication with a first side of each of the loads 12, through a common electrical interconnect represented by a remote node 18. In one embodiment, the remote node 18 represents a common interconnect at a distant location, as measured along the interconnecting electrical conductor, from the variable power supply 10. Referring to FIG. 2, the remote node 18 is shown located between a load 12B and a load 12N. However, since FIG. 2 is a schematic circuit representation, the node 18 could equivalently be located at any point between the variable power supply 10 and the load 12 located at the most remote distance. Details reflecting the actual distances and locations of the loads 12 with respect to the variable power supply 10 are not apparent from a schematic diagram such as FIG. 2, but would be provided from a layout diagram.

A second side of each of the loads 12 is in electrical communication with the variable power supply 10 supply sense return terminal (RETURN), with the remote active boost regulator 20 regulation sense return terminal and with a circuit reference potential. For the embodiment shown in FIG. 2, the sense return input is also in electrical communication with a ground potential representing, substantially, a relative zero circuit reference potential value. The remote active boost regulator 20 regulator input terminal is in electrical communication with the remote node 18, and the remote active boost regulator 20 regulator output terminal is in electrical communication with the variable power supply 10 supply input terminal.

In a realization of an embodiment of the invention, a portion of the variable power supply 10 output power will be dissipated, or lost, before the power is delivered to the loads 12. This loss is attributable to an equivalent impedance of the current carrying conductors of the power distribution system and is related to their finite conductivity. Referring to FIG. 2, the characteristic impedance is shown in as phantom resistive elements indicating that the resistance is due to the conductor, and not an actual resistor element. A resistive element 14 represents the equivalent impedance attributed to the segment of the power distribution system located between the variable power supply 10 and the remote node 18. Equivalent impedances 16A through 16N (generally 16) of each segment of the circuit are shown in phantom and represent the equivalent impedance between the remote node 18 and each individual load 12. Summation of the variable power supply 10 output voltage, the voltage drop across the resistive element 14 yields the equivalent voltage at the node 18. Summation of the voltage at the node 18 and each of the resistive elements 16, yields the voltage value supplied to each of the respective loads 12.

Generally, the remote active boost regulator 20 measures the voltage value at the remote node 18, compares that value to a reference voltage, and generates a feedback signal being a function of the difference between the two values. The feedback signal is provided as an output signal on the remote active boost regulator 20 regulator output terminal. The feedback signal is provided as an input to the variable power supply 10 and causes the variable power supply 10 to adjust its output voltage, when necessary. The regulating action allows the variable power supply 10 output to be maintained at a substantially fixed value, even under conditions of changing loads, such as when the loads 12, representing circuit cards, are removed or replaced from a back-plane while power is applied.

In one embodiment, a nominal supply voltage value is provided at the loads 12, by providing a requested voltage value at the remote node 18 that is an amount greater than the nominal supply voltage. The amount by which the nominal variable power supply 10 output is boosted is predetermined to be a value sufficient to compensate for the additional voltage drop across each resistive element 16 between the remote node 18 and each respective load 12. In another embodiment, the remote active boost regulator 20 provides a feedback signal to the variable power supply 10 providing a supply output voltage of sufficient magnitude to result in a voltage value at the remote node 18 that is between approximately 2% and approximately 4% above the nominal supply voltage, compensating for additional voltage drops due to the electrical conductors interconnecting the remote node 18 to the individual loads 12, represented by an equivalent resistive elements 16. In one embodiment, the variable power supply 10 nominal output voltage is between approximately 0.5 volts and approximately 15 volts. In another embodiment, the variable power supply 10 nominal output voltage is more than approximately 3.3 volts. In yet another embodiment, the variable power supply 10 nominal output voltage is more than approximately 5 volts. In yet other embodiments, the variable power supply 10 nominal output voltage operates at 12 volts, or 24 volts, or 48 volts, for such applications as powering Direct Current (DC)/DC converters, disk drive motors, and cooling fans.

A preferred embodiment includes a variable power supply 10 that is a low-voltage DC power supply. Other embodiments are possible where the variable power supply 10 is a regulating high-voltage DC power supply.

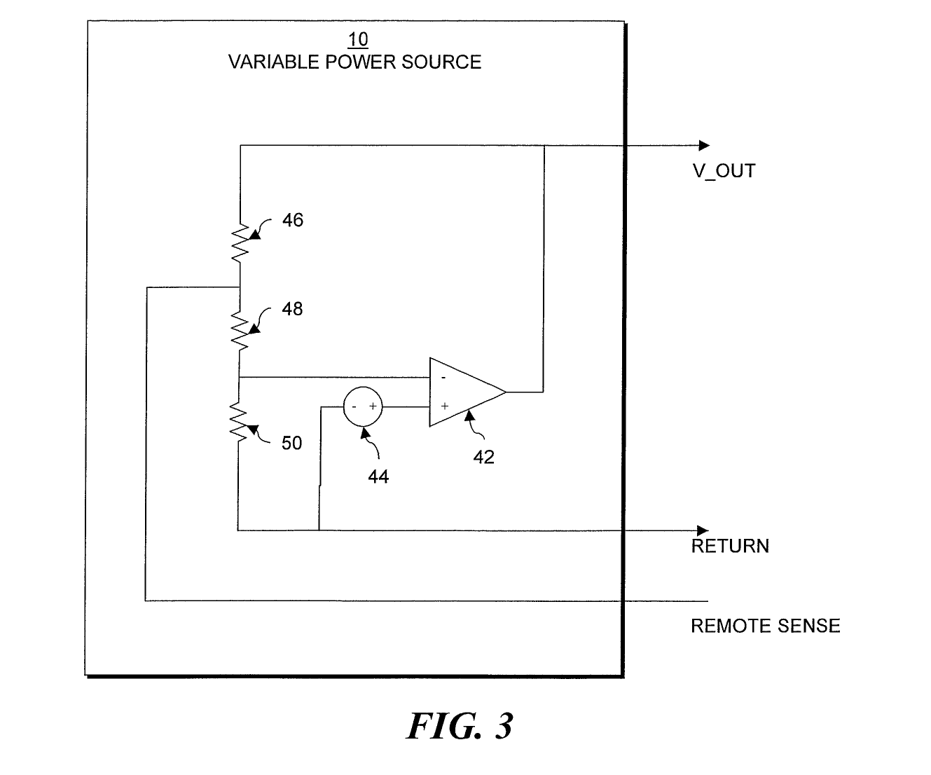

Referring to FIG. 3, in one embodiment, the variable power supply 10 includes a non-inverting power amplifier 42, and a reference source 44. A first (non-inverting) input to the amplifier 42 is connected to a first side of a the reference source 44. A second side of the reference source 44 is connected to a ground potential. The output of the amplifier 42 is connected to the variable power supply 10 output terminal (V_OUT) and to a second (inverting) input to the amplifier 42, through at least two resistive elements 46 and 48. The inverting input of the amplifier 42 is also connected to the variable power supply 10 return terminal (RETURN) through a resistive element 50. The variable power supply 10 remote sense input (REMOTE SENSE) is connected to a second input of the amplifier 42, through a resistive element 48.

The variable power supply 10 provides a primary voltage delivered to the distributed loads shown in FIG. 2. The regulated output voltage is supplied across the variable power supply 10 output terminals: V_OUT; and RETURN. Referring again to FIG. 3, the amplifier 42 provides a gain control mechanism for the output voltage. The amplifier 42 includes a feedback path, where control through the feedback path can be used to increase or decrease the variable power supply 10 output voltage signal as a function of the signal present at the inputs to amplifier 42 and the particular selected values of the resistive components (46, 48, and 50). In one embodiment, the variable power supply 10 remote sense input accepts a current signal from the remote active boost regulator 20. This current input signal is also input into the inverting terminal of the amplifier 42 providing a remote sense feedback signal that controls the output of the amplifier 42 and can be used to further regulate the output by increasing or decreasing the output voltage.

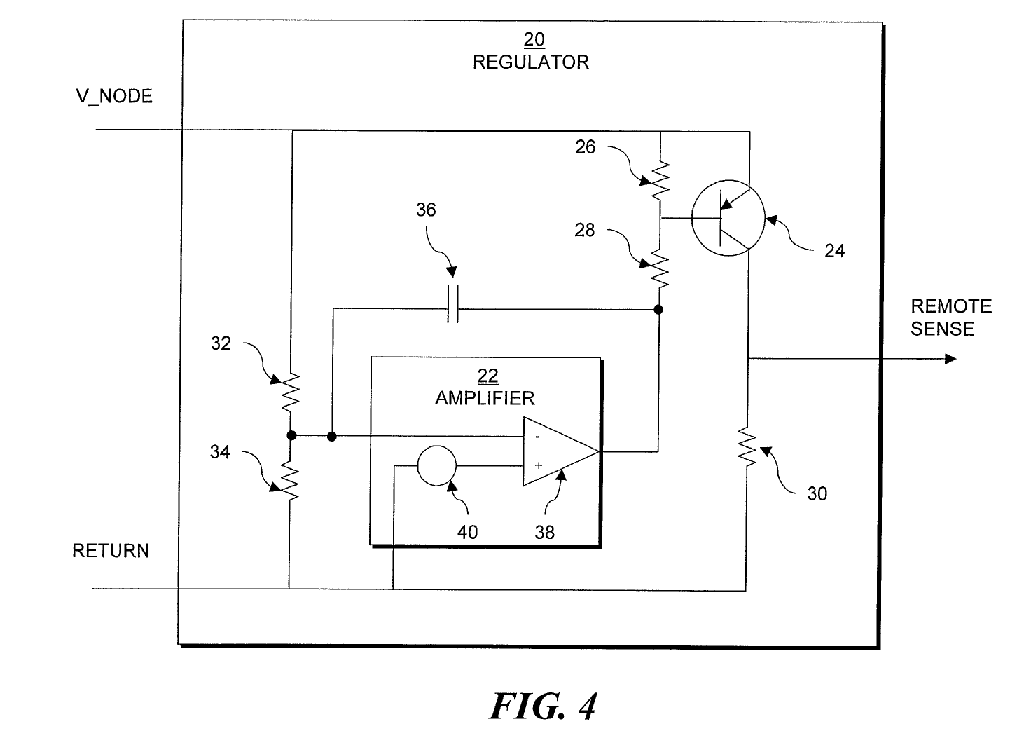

Referring to FIG. 4, in one embodiment, the remote active boost regulator 20 includes a two-stage amplifier including a first-stage amplifier 22 and a second-stage transistor amplifier 24. The base terminal of the transistor 24 is connected to the emitter terminal of the transistor 24 through a resistive element 26. The base terminal of the transistor 24 is also connected to the amplifier 22 output through a resistive element 28. The emitter terminal of the transistor 24 is connected to the remote active boost regulator 20 voltage sensing input terminal (V_NODE) and a first input terminal of the amplifier 22 through a resistive element 32. The collector terminal of the transistor 24 is connected to the remote active boost regulator 20 output terminal (REMOTE SENSE) and to the remote active boost regulator 20 return terminal through a resistive element 30. The output of the amplifier 22 is also connected to a first input of the amplifier 22 through a capacitive element 36.

The first-stage amplifier 22 amplifies the voltage difference measured at the input of the amplifier 38 between the measured voltage at remote node 18 of FIG. 2, and a reference source 40. The amplifier 38 amplifies the difference and provides it as an output voltage signal. The first-stage amplifier 22 voltage signal is input to the second-stage amplifier where it is applied to the base of the transistor 24. The transistor 24 acts as a current amplifier, amplifying the current related to the output of the first-stage amplifier 22. The amplified current resides on the collector of transistor 24 and is provided as an output representing the remote active boost regulator 20 feedback signal. The capacitive element 36, and resistive elements act in combination with the amplifier 22 and the transistor 24, to provide a loop response time. The loop response time is an indication of how fast the remote active boost regulator 20 can respond to a change in the measured voltage. The loop response time can be varied depending upon the selection of the components. The remote active boost regulator 20 loop response time is selected to be compatible with the loop response time of the variable power supply 10, so that the combined circuit does not adversely impact the original stability, or response time, of the variable power supply 10 alone.

Other embodiments are possible where feedback signals provided by the remote active regulator 20 consist of modulated signals, such as pulse-width modulated signals, frequency modulated signals, or phase shift keyed modulated signals. Other embodiments are also possible where the feedback signal is converted from an analog to digital signal and transmitted to the variable power supply 10 as a digital number, where it is subsequently transformed back into an analog feedback signal at the input to the variable power supply 10. Yet other embodiments are possible where the feedback signals provided by the remote active regulator 20 are provided over fiber-optic cables, perhaps to overcome electromagnetic interference with the feedback signal in electrically “noisy” environments.

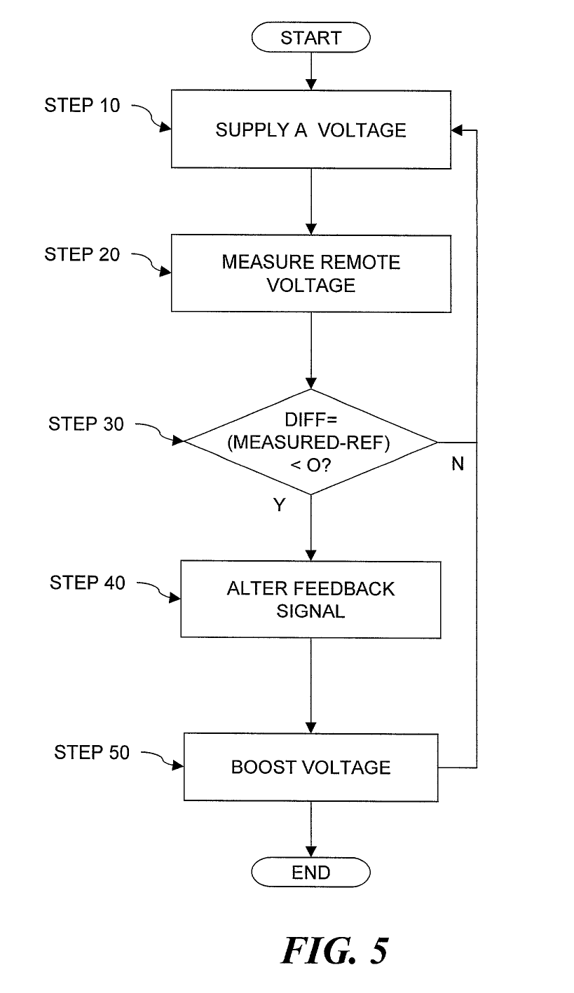

An embodiment of the distributed load power distribution system with remote active boost regulation is shown in FIG. 5. After system power-up, the variable power supply 10 provides input power to the power distribution system, shown in FIG. 2 as loads 12 (step 10). The current flows throughout the power distribution system to each load 12, experiencing voltage drops resulting from the equivalent impedance of the interconnecting leads (14 or 16). The remote active boost regulator 20 measures the voltage at a the remote node 18 (step 20). This voltage for the embodiment shown in FIG. 2, is the variable power supply 10 output voltage level at the supply terminal less the value of the resistive drop attributable to the segments of the power distribution system between the variable power supply 10 and the remote node 18, and are calculated as the supply output current multiplied by the resistive value 14. The remote active boost regulator 20 compares the voltage measured at the remote node 18 with a reference voltage to determine any difference between the two values (step 30). Where a difference exists between the voltage measured a the remote node 18 and the reference voltage, the remote active regulator 20 alters a feedback signal and delivers it to the remote sense terminal of the variable power supply 10 (step 40). The variable power supply 10 accepts the feedback signal input from the remote active regulator 20 and adjusts its output level in response, providing a boost voltage where the voltage measured at the remote node 18 is below the reference voltage (step 50).

Having shown the preferred embodiments, one skilled in the art will realize that many variations are possible within the scope and spirit of the claimed invention. It is therefor the intention to limit the invention only by the scope of the claims.

What is claimed is:

1. A power system with remote boost regulation, comprising:
a variable power supply comprising:
a supply output terminal, providing a supply output voltage; and
a supply input terminal, receiving a feedback signal; and
a supply sense return terminal, receiving a system zero reference voltage; and
a remote active boost regulator comprising:
a regulator input terminal in electrical communication with said supply output terminal and said supply reference terminal, receiving said supply output voltage;
a regulator output terminal in electrical communication with said supply input terminal and said supply sense return terminal, said regulator output terminal supplying said feedback signal; and
a regulator sense return terminal in electrical communication with said supply sense return terminal, receiving said system zero reference voltage,
wherein said remote active boost regulator monitors said supply output voltage and generates said feedback signal causing said variable power supply output to be boosted above its nominal voltage value and adjust said supply output voltage to compensate for distribution losses and remote loading.

2. The power system of claim 1 further comprising at least one load in electrical communication with said supply output terminal and said supply sense return terminal.

3. The power system of claim 1, wherein the remote active regulator comprises:
a differential voltage amplifier, comprising:
an input terminal in electrical communication with said regulator sense return terminal and said regulator input terminal, receiving a first input voltage; and
an output terminal in electrical communication with said input terminal, providing a first output voltage;
a reference terminal in electrical communication with said regulator sense return terminal; and
a amplifier comprising:
a base terminal in electrical communication with said input terminal and said output terminal and receiving said first output voltage;
an emitter terminal in electrical communication with said base terminal and said input terminal, receiving said supply output voltage;
and a collector terminal in electrical communication with said regulator sense return terminal and said regulator output terminal, providing said feedback signal current,
wherein said first output voltage is a function of said supply output voltage, and said amplifier converts said first output voltage into said feedback signal.

4. The remote active regulator of claim 3 wherein said emitter terminal is in electrical communication with said input terminal through at least one resistive element.

5. The remote active regulator of claim 3 wherein said input terminal is in electrical communication with said regulator sense return terminal through at least one resistive element.

6. The remote active regulator of claim 3 wherein said collector terminal is in electrical communication with said regulator sense return terminal through at least one resistive element.

7. The remote active regulator of claim 3 wherein said base terminal is in electrical communication with said output terminal through at least one resistive element.

8. The remote active regulator of claim 3 wherein said emitter terminal is in electrical communication with said base terminal through at least one resistive element.

9. The remote active regulator of claim 3 wherein said output terminal is in electrical communication with said input terminal through at least one capacitive element.

10. The remote active regulator of claim 3 wherein said differential voltage amplifier comprises:
a reference voltage source in electrical communication with said sense return terminal, providing a reference voltage; and
a differential amplifier, comprising:
a first amplifier input terminal in electrical communication with said input terminal;
a second amplifier input terminal in electrical communication with said reference voltage source and receiving said reference voltage source; and
an amplifier output terminal in electrical communication with said output terminal, providing said first output voltage,
wherein said first output voltage is a function of the difference in voltage between said first amplifier input terminal and said second amplifier input terminal.

11. The amplifier of claim 3 wherein said amplifier comprises a PNP transistor.

12. The power system of claim 1, wherein the variable power supply comprises:
a reference voltage source in electrical communication with said supply sense return terminal, providing a reference voltage; and
a differential amplifier, comprising:
a first amplifier input terminal in electrical communication with said supply input terminal and said supply output terminal and said supply sense return terminal;
a second amplifier input terminal in electrical communication with said reference voltage source, said second amplifier input terminal receiving said reference voltage source; and
an amplifier output terminal in electrical communication with said supply output terminal.

13. The differential amplifier of claim 12 wherein said first amplifier input terminal is in electrical communication with said supply input terminal through at least one resistive element.

14. The differential amplifier of claim 12 wherein said first amplifier input terminal is in electrical communication with said supply output terminal through at least one resistive element.

15. The differential amplifier of claim 12 wherein said first amplifier input terminal is in electrical communication with said supply sense return terminal through at least one resistive element.

16. A power system with remote boost regulation for connection with a variable power supply, comprising:
a remote active boost regulator comprising:
a regulator input terminal in electrical communication with a variable power supply output terminal and a variable power supply sense return terminal, receiving said variable power supply output voltage;
a regulator output terminal in electrical communication with a variable power supply input terminal and a variable power supply sense return terminal, said regulator output terminal supplying a feedback signal to the variable power supply; and
a regulator sense return terminal in electrical communication with a variable power supply sense return terminal, receiving a system zero reference voltage,
wherein said remote active boost regulator monitors the variable power supply output voltage and generates said feedback signal, boosting said variable power supply output above a nominal voltage value to compensate for distribution losses and remote loading.

17. The power system of claim 16 further comprising at least one load in electrical communication with said supply output terminal and said supply sense return terminal.

18. The power system of claim 16, wherein the remote active regulator comprises:
a differential voltage amplifier, comprising:
an input terminal in electrical communication with said regulator sense return terminal and said regulator input terminal, receiving a first input voltage; and
an output terminal in electrical communication with said input terminal, providing a first output voltage;
a reference terminal in electrical communication with said regulator sense return terminal; and
a amplifier comprising:
a base terminal in electrical communication with said input terminal and said output terminal and receiving said first output voltage;
an emitter terminal in electrical communication with said base terminal and said input terminal, receiving said supply output voltage;
and a collector terminal in electrical communication with said regulator sense return terminal and said regulator output terminal, providing said feedback signal current,
wherein said first output voltage is a function of said supply output voltage, and said amplifier converts said first output voltage into said feedback signal.

19. The remote active regulator of claim 18 wherein said differential voltage amplifier comprises:
a reference voltage source in electrical communication with said sense return terminal, providing a reference voltage; and
a differential amplifier, comprising:
a first amplifier input terminal in electrical communication with said input terminal;
a second amplifier input terminal in electrical communication with said reference voltage source and receiving said reference voltage source; and
an amplifier output terminal in electrical communication with said output terminal, providing said first output voltage,
wherein said first output voltage is a function of the difference in voltage between said first amplifier input terminal and said second amplifier input terminal

20. The remote active boost regulator of claim 16 wherein the nominal power supply output is boosted more than approximately 2%.

21. The remote active boost regulator of claim 16 wherein the nominal power supply output is boosted by between approximately 2% and approximately 4%.

22. The power system of claim 16 wherein the variable power supply is a Direct Current (DC) power supply.

23. The power system of claim 22 wherein the variable power supply nominal output is between approximately 0.5 volts and approximately 15 volts.

24. The power system of claim 22 wherein the variable power supply nominal output is more than approximately 3.3 volts.

25. The power system of claim 22 wherein the variable power supply nominal output is more than 5 volts.

26. A method for reducing the effect of transmission losses in a distributed power system, comprising:
(a) supplying a provided boost voltage to a distributed power system;
(b) measuring a measured voltage value at a remote point in the distributed power system;
(c) comparing the measured voltage value with a reference voltage value;
(d) changing a feedback signal in response to any difference in the comparison in step (c); and
(e) changing the provided voltage by an amount greater than said difference in response to said change in said reference signal in step (d).

27. The method of claim 26 further comprising the step of repeating said steps (a) through (e).
